(19) United States
(12) Patent Application Publication
(10) Pub. No.: US 2025/0296327 A1
(43) Pub. Date: Sep. 25, 2025

(54) LIQUID DISCHARGE HEAD AND LIQUID DISCHARGE APPARATUS

(71) Applicant: CANON KABUSHIKI KAISHA, Tokyo (JP)

(72) Inventors: TOMOAKI KAMAGATA, Kanagawa (JP); YASUAKI KITAYAMA, Kanagawa (JP)

(21) Appl. No.: 19/087,266

(22) Filed: Mar. 21, 2025

(30) Foreign Application Priority Data
Mar. 25, 2024 (JP) 2024-048283

(51) Int. Cl. B41J 2/14; B41J 2/045; B41J 2/18

(52) U.S. Cl. CPC B41J 2/14201; B41J 2/04581; B41J 2/18; B41J 2002/14491; B41J 2202/19

(57) ABSTRACT

A liquid discharge head includes a plurality of discharge units each including a discharge element substrate configured to discharge liquid, a pressure adjustment unit configured to reserve the liquid to be discharged from the discharge element substrate and to adjust a pressure of the liquid, and a support member configured to fluid-connect the discharge element substrate and the pressure adjustment unit and to support the discharge element substrate, wherein the plurality of discharge units is arranged in a juxtaposed manner.

### BACKGROUND

### Field

The present disclosure relates to a liquid discharge head and a liquid discharge apparatus.

### Description of the Related Art

A liquid discharge apparatus includes a liquid discharge head for discharging liquid to achieve a desired purpose thereby. For example, an inkjet recording apparatus is provided with an inkjet recording head serving as a liquid discharge head on a carriage to record images, characters, and the like on a recording medium, by discharging ink from each discharge element substrate included in the ink jet recording head. The liquid discharge head includes the discharge element substrates for discharging ink, liquid reservoirs for reserving the ink, and support members for respectively fluid-connecting the discharge element substrates and the liquid reservoirs, and supporting the discharge element substrates. A configuration for making nozzle arrays multi-rowed by arranging a plurality of discharge element substrates in a juxtaposed manner, or a configuration for making nozzle arrays apparently longer by arranging the nozzle arrays in a staggered manner are proposed.

Japanese Patent Application Laid-open No. 2016-20031 discusses a liquid discharge head that has achieved multi-rowed nozzle arrays by providing a plurality of discharge element substrates for one support member integrally formed with a plurality of liquid flow paths.

When the liquid discharge head is manufactured, it is desirable to design the liquid discharge head so as to have freedom as much as possible, in consideration of applying the liquid discharge head to a wide variety of products.

However, with the configuration discussed in Japanese Patent Application Laid-open No. 2016-20031, in order to manufacture a new liquid discharge head with the number or the arrangement of the discharge element substrates changed, a new support member or a new liquid reservoir suitable for the changed number of discharge element substrates is required. Thus, the applicability of each component becomes low. Further, even if only a part of the component has a failure, there is a concern that the component may need to be replaced including parts with no failures because an integrally formed component is used.

### SUMMARY

The present disclosure is directed to a liquid discharge head with an increased design freedom degree.

According to some embodiments, a liquid discharge head includes a plurality of discharge units each including a discharge element substrate configured to discharge liquid, a pressure adjustment unit configured to reserve the liquid to be discharged from the discharge element substrate and to adjust a pressure of the liquid, and a support member configured to fluid-connect the discharge element substrate and the pressure adjustment unit and to support the discharge element substrate, wherein the plurality of discharge units is arranged in a juxtaposed manner.

Further features of the present disclosure will become apparent from the following description of exemplary embodiments with reference to the attached drawings.

### BRIEF DESCRIPTION OF THE DRAWINGS

FIGS. 1A and 1B are perspective views illustrating a liquid discharge unit and a liquid discharge head, respectively.

FIG. 2 is a schematic view illustrating a pressure adjustment unit.

FIGS. 3A and 3B are an exploded view and a perspective view, respectively, illustrating a liquid discharge head provided with a fixing member.

FIGS. 4A and 4B are an exploded view and a perspective view, respectively, illustrating the liquid discharge head with an electric wiring substrate.

FIG. 5 is a bottom view illustrating a liquid discharge head.

FIG. 6 is a bottom view illustrating a liquid discharge head.

FIG. 7 is a bottom view illustrating a liquid discharge head.

### DESCRIPTION OF THE EMBODIMENTS

Hereinbelow, various exemplary embodiments, features, and aspects of the present disclosure will be described with reference to the attached drawings. Note that the exemplary embodiments described below are not intended to limit the range of the present disclosure, and not all the combinations of the features described in the exemplary embodiments are necessarily essential for the solution of the present disclosure. In addition, the same reference numbers are assigned to the same components.

A liquid discharge unit and a liquid discharge head according to a first exemplary embodiment are an ink discharge unit and an inkjet head that discharge ink, but the liquid discharge unit and the liquid discharge head are not limited to an ink discharge unit and an inkjet head as long as they discharge liquid.

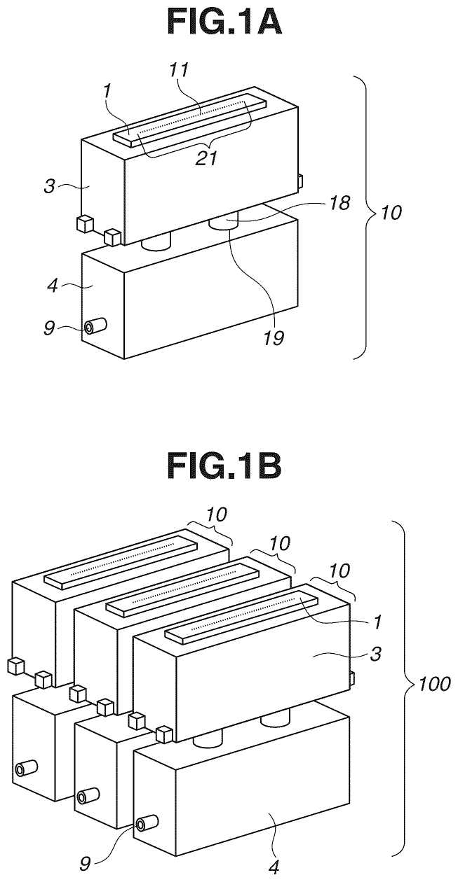

FIG. 1A is a perspective view illustrating a liquid discharge unit according to the present exemplary embodiment. A liquid discharge unit 10 includes a discharge element substrate 1 for discharging liquid, a pressure adjustment unit 4 for reserving the liquid to be discharged from the discharge element substrate 1 and adjusting the pressure of the liquid, and a support member 3 for fluid-connecting the discharge element substrate 1 and the pressure adjustment unit 4, and supporting the discharge element substrate 1. The discharge element substrate 1 discharges liquid from a discharge port array 21 including a plurality of discharge ports 11, by a pressure generated by driving an energy-generation element (not illustrated) and acting on the liquid in a pressure chamber (not illustrated). The energy-generation element may be a thermoelectric conversion element, a piezoelectric element, or another energy-generation element. The pressure adjustment unit 4 has a supply port 9 to which liquid is supplied from outside the liquid discharge unit 10. Details of the pressure adjustment unit 4 will be described below.

The support member 3 has a connection portion 18 to be connected to a connection opening 19 of the pressure adjustment unit 4. The support member 3 may support the discharge element substrate 1 directly or indirectly. More specifically, another member may be sandwiched between the discharge element substrate 1 and the support member 3.

The pressure adjustment unit 4 has a supply port 9 to which liquid is supplied from outside the liquid discharge unit 10. The liquid reserved in the pressure adjustment unit 4 is supplied to the discharge element substrate 1 via the support member 3 provided with liquid paths therein, and discharged to a recoding medium from the discharge ports 11 of the discharge element substrate 1. The number of the liquid paths in the support member 3 is the number of kinds of the liquids to be discharged by the discharge element substrate 1 or more, and the liquid paths are configured so as to prevent the mixing of liquids by partitioning the liquid paths independently for each of the kinds of the liquids.

A liquid discharge head 100 is mounted on a carriage of a liquid discharge apparatus (not illustrated). The liquid discharge head 100 may be a serial head that moves relative to a recording medium onto which the liquid is discharged from the liquid discharge head 100, or a full-line head in which a plurality of the liquid discharge units 10 is juxtaposed in a line. A moving direction of the carriage and a juxtaposition direction of the liquid discharge units 10 will be described below.

FIG. 1B is a perspective view illustrating the liquid discharge head 100. The liquid discharge head 100 includes a plurality of the liquid discharge units 10, and has a configuration with the liquid discharge units 10 arranged in a juxtaposed manner. FIG. 1B illustrates an example in which the liquid discharge head 100 has the three liquid discharge units 10 arranged in a juxtaposed manner at equal pitches, but the number and the arrangement of the liquid discharge units 10 are not limited to the example. In other words, in a case where the number of kinds of the liquids is to be increased or the recording speed is to be made faster, the number of the discharge ports 11 can be increased by increasing the number of the liquid discharge units 10, and the liquid discharge head 100 with a desired specification can be configured. In this way, the liquid discharge head 100 with a design freedom degree increased can be obtained.

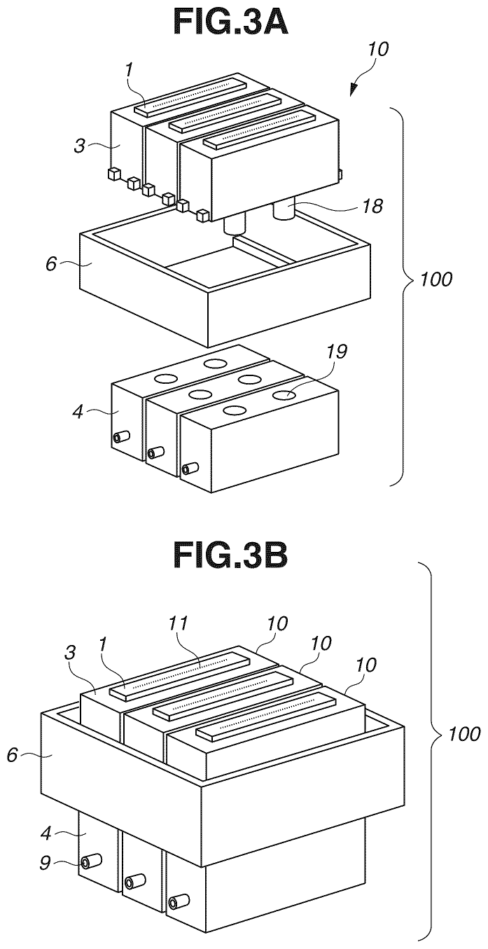

All the liquid discharge units 10 mounted on the liquid discharge head 100 are desirably configured of the same components. In a case where all the liquid discharge units 10 are composed of the same components, it is possible to disassemble the once assembled liquid discharge head 100 to take out the liquid discharge unit 10, and build it in another liquid discharge head 100 to use it again. With this configuration, the liquid discharge unit 10 with the same configuration may be manufactured, and it is possible to use a manufacturing equipment in common. An efficient manufacturing is possible by making the manufacturing equipment have the extensibility so that the fixing position of each of the liquid discharge units 10 can be set by a program for each model, because the change used for each of the different liquid discharge heads 100 is a device for fixing the liquid discharge unit 10 to a fixing member 6 (see FIG. 3A).

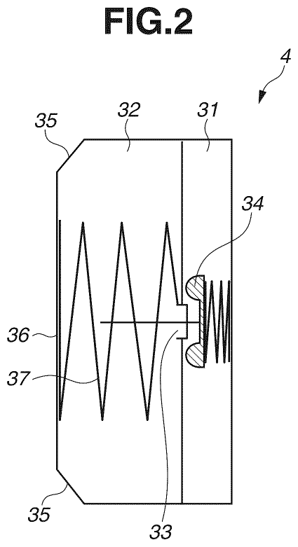

FIG. 2 illustrates a preferred form of the pressure adjustment unit 4. The pressure adjustment unit 4 includes a spring bag for adjusting the pressure therein. The pressure adjustment unit 4 desirably includes a valve chamber 31, a pressure adjustment chamber 32, an opening 33 for communicating the valve chamber 31 and the pressure adjustment chamber 32, and a valve 34 configured to be able to open and close the opening 33. A part of the surface of the pressure adjustment chamber 32 is formed with a flexible member 35 to be displaceable. The pressure adjustment chamber 32 includes a pressure plate 36 displaceable in conjunction with the flexible member 35, an urging member 37 urging the pressure plate 36 in a direction in which the inner volume of the pressure adjustment chamber 32 increases, and configured to be able to open and close the valve 34 depending on the displacement of the pressure plate 36 and the flexible member 35.

With this configuration, since the valve 34 is opened and closed by the pressure in the pressure adjustment chamber 32, the pressure of the liquid reserved in the pressure adjustment chamber 32 can be adjusted. The pressure adjustment unit 4 desirably includes a circulation pump (not illustrated) for circulating the liquid in the liquid discharge unit 10. The configuration of the pressure adjustment unit 4 is not limited to the above-described configuration, and the pressure adjustment unit 4 may be configured to be able to reserve the liquid to be discharged from the discharge element substrate 1, and to be able to adjust the pressure of the liquid.

With the above-described configuration, in a case where the liquid discharge head 100 with a different kind of discharge liquid or the different number of the discharge element substrates 1 is to be manufactured, since the liquid discharge units 10 can be arbitrarily arranged, the design freedom degree can be increased. In a manufacturing method of the liquid discharge head 100, even the different kind of the liquid discharge head 100 can be manufactured using common steps up to the step of manufacturing the liquid discharge unit 10. Thus, it is possible to reduce the costs of manufacturing the liquid discharge head 100, and to efficiently manufacture the liquid discharge head 100. In a case where a part of the liquid discharge units 10 in the liquid discharge head 100 has a failure, since it is possible to repair the liquid discharge head 100 only by replacing the failed liquid discharge unit 10, the repair of the whole liquid discharge head 100 is not necessary.

A configuration of the liquid discharge head 100 according to a second exemplary embodiment of the present disclosure will be described. In the descriptions below, only parts different from the first exemplary embodiment will be mainly described, and similar parts will not be described.

FIG. 3A is an exploded perspective view illustrating the liquid discharge head 100 according to the second exemplary embodiment, and FIG. 3B is a perspective view illustrating the liquid discharge head 100 in an assembled state according to the second exemplary embodiment. The liquid discharge head 100 according to the second exemplary embodiment is different from that in the first exemplary embodiment in that it has the fixing member 6 for integrally fixing the plurality of liquid discharge units 10. The “fixing” may mean any of a configuration that is difficult to attach and detach, such as bonding and welding, and a configuration that is easy to attach and detach, such as snap fitting and screwing. The “fixing” may not be a state where the liquid discharge unit 10 cannot move at all relative to the fixing member 6, and may be a state where there is a restriction on moving the liquid discharge unit 10 relative to the fixing member 6.

The liquid discharge unit 10 is fixed by being fixed to the fixing member 6. At this time, in a case where a relative distance between the discharge element substrates 1 is important, it is desirable to measure the position of the discharge element substrate 1 using an image processing device or the like after fixing one of the liquid discharge units 10, and to fix the other liquid discharge unit 10 at a desired distance therefrom. In a case where the liquid discharge head 100 includes three or more of the liquid discharge units 10, and a positional accuracy between the discharge element substrates 1 of the liquid discharge unit 10 is desired, such steps may be simply repeated. Each of the liquid discharge units 10 may be fixed to the fixing member 6 in a state where the support member 3 and the pressure adjustment unit 4 are assembled, or after the fixing member 6 is sandwiched by the support member 3 and the pressure adjustment unit 4.

A configuration of the liquid discharge head 100 according to a third exemplary embodiment of the present disclosure will be described.

In order to mount the liquid discharge head 100 on the liquid discharge apparatus and to drive the energy-generation elements on the discharge element substrates 1, each of the liquid discharge units 10 may be electrically contacted. In many cases, this work is performed by a maker manufacturing the liquid discharge head 100, but in some cases, this work is performed by a user of the liquid discharge apparatus. In this case, making the electrical connections to the plurality of liquid discharge units 10 one by one uses many electrical contacts between each of the liquid discharge units 10 and the liquid discharge apparatus, and there is a concern of decrease in usability, and increase in costs due to increase of the number of components.

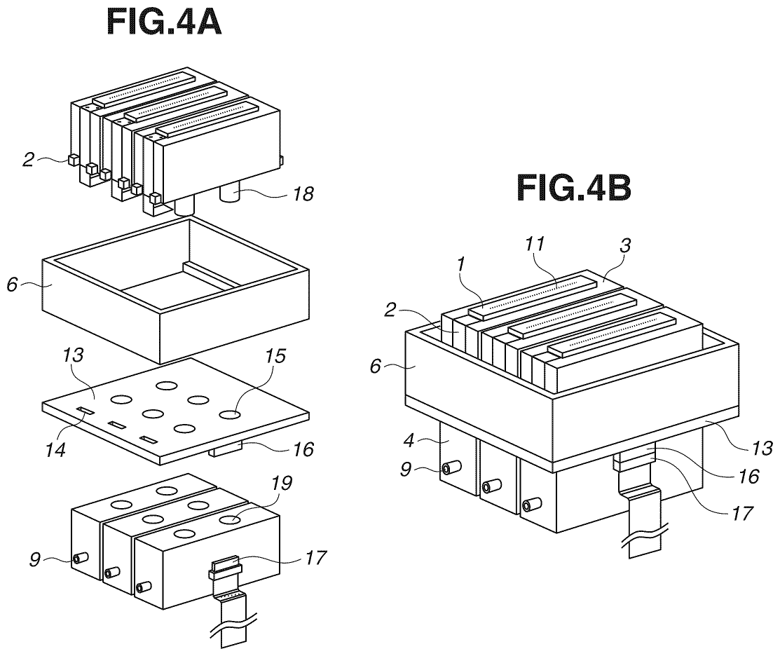

FIG. 4A is an exploded perspective view illustrating the liquid discharge head 100 according to the third exemplary embodiment, and FIG. 4B is a perspective view illustrating the liquid discharge head 100 in an assembled state, according to the third exemplary embodiment. In the third exemplary embodiment, the liquid discharge head 100 includes an electric wiring substrate 13 for receiving power from “outside the liquid discharge head 100”, and each of the plurality of liquid discharge units 10 has an electric connection member 2 for connecting to the electric wiring substrate 13.

“Outside the liquid discharge head 100” is, for example, the liquid discharge apparatus provided with the liquid discharge head 100. In this case, the electric wiring substrate 13 receives power supplied from the liquid discharge apparatus via a power reception connector 16, and power for driving the energy-generation elements of each of the discharge element substrates 1 is supplied from the electric wiring substrate 13 via the electric connection member 2. With this configuration, it is possible to supply power to the discharge element substrate 1 of each of the liquid discharge units 10 via the electric wiring substrate 13, just by connecting a power transmission connector 17 of the liquid discharge apparatus to the power reception connector 16 when the liquid discharge head 100 is to be mounted on the liquid discharge apparatus.

There is a case where the pressure adjustment unit 4 is provided with a circulation pump for circulating the liquid in each of the liquid discharge units 10. Even in such a case, it is possible to supply power for driving the circulation pump from the electric wiring substrate 13 by providing a wiring member from the circulation pump to electrically connect to the electric wiring substrate 13.

The electric wiring substrate 13 is desirably arranged between the support member 3 and the pressure adjustment unit 4. With this arrangement, the distance from the electric wiring substrate 13 for arranging the electric connection member 2 can be designed to be short, and accordingly the costs can be reduced. The position of the electric wiring substrate 13 is not limited to a position between the support member 3 and the pressure adjustment unit 4. In FIGS. 4A and 4B, the electric connection member 2 is arranged on a short side of each of the discharge element substrates 1, but may be arranged on a long side of each of the discharge element substrates 1, and also a plurality of the electric connection members 2 may be arranged on both sides of each of the discharge element substrates 1 so as to have a symmetrical shape.

An example of manufacturing the liquid discharge head 100 according to the present exemplary embodiment will be described. First, the electric wiring substrate 13 is fixed to the bottom of the fixing member 6. Next, the electric connection member 2 fixed to the support members 3 is drawn out from the support member 3 to the pressure adjustment unit 4 via an opening 15 provided in the electric wiring substrate 13, and is connected and fixed. Then, the connection portion 18 of the support member 3 and the connection opening 19 of the pressure adjustment unit 4 are connected with each other using male and female joints via the opening 15 in the electric wiring substrate 13. The liquid discharge head 100 can be manufactured by repeating this process the number of times corresponding to the number of the liquid discharge units 10 to be mounted on the liquid discharge head 100.

The electric wiring substrate 13 may be designed in such a manner that unit circuits for sending signals independently to the respective liquid discharge units 10 are provided on the electric wiring substrate 13, and arranged on the electric wiring substrate 13 at positions corresponding to the mounted liquid discharge units 10. Accordingly, even if the number of the liquid discharge units 10 mounted on the liquid discharge head 100 increases, it is possible to reduce the costs because the circuit design does not need time and labor. In also the manufacturing method of the liquid discharge head 100, an effect that the manufacturing steps become simple can be obtained, because the same liquid discharge units 10 may be connected to the electric wiring substrate 13 in a similar manner.

With the configuration described above, it is possible to electrically connect the power transmission connector 17 of the liquid discharge apparatus to the power reception connector 16 of the electric wiring substrate 13, without need to connect a plurality of wiring lines for each discharge element substrate 1 or the pressure adjustment unit 4, while the design freedom degree of the liquid discharge head is increased. Thus, it is possible to suppress the decrease in usability and the increase in cost due to the increase of the number of components.

Configurations of the liquid discharge head 100 according to other exemplary embodiments of the present disclosure will be described. In the other exemplary embodiments, the direction (first direction) in which the liquid discharge units 10 are juxtaposed, the direction (second direction) in which each of the discharge port arrays 21 extends, and a direction in which the carriage moves will be described.

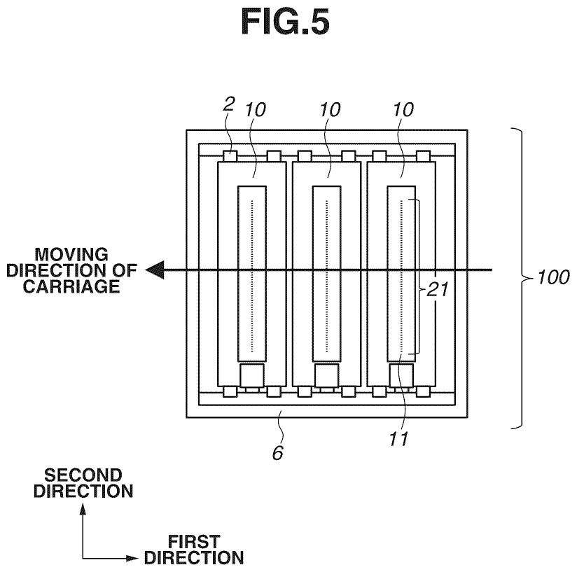

FIG. 5 is a bottom view illustrating the liquid discharge head 100 according to one of the other exemplary embodiments. In FIG. 5, a plurality of the liquid discharge units 10 is juxtaposed in the first direction, and each of the discharge port arrays 21 extends in the second direction intersecting with the first direction.

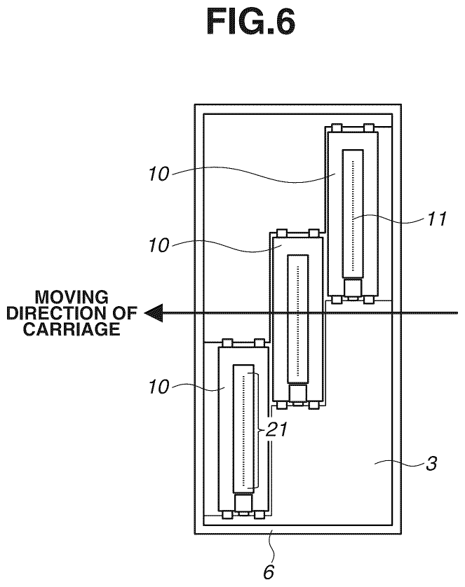

FIG. 6 is a bottom view illustrating the liquid discharge head 100 according to another one of the other exemplary embodiments. In FIG. 6, a plurality of the liquid discharge units 10 is juxtaposed in the first direction, each of the discharge port arrays 21 extends in the second direction intersecting with the first direction, and each of the plurality of liquid discharge units 10 has an overlapping area when viewed from the first direction. In this case, the carriage desirably moves in the first direction. With this configuration, it is possible to record a clear image while enabling the number of kinds of the dischargeable liquids to increase or decrease arbitrarily by arranging the plurality of liquid discharge units 10.

In general, in order to increase the image recording speed, there is a method of increasing the carriage moving speed, or increasing a recording area for one scan by increasing the length of each of the discharge port arrays 21 dischargeable by one carriage movement. However, from a view point of droplet landing accuracy control, the carriage speed of the liquid discharge head has a certain limit, and it is not easy to change the length of each of the discharge port arrays 21 so as to match the specification of the model.

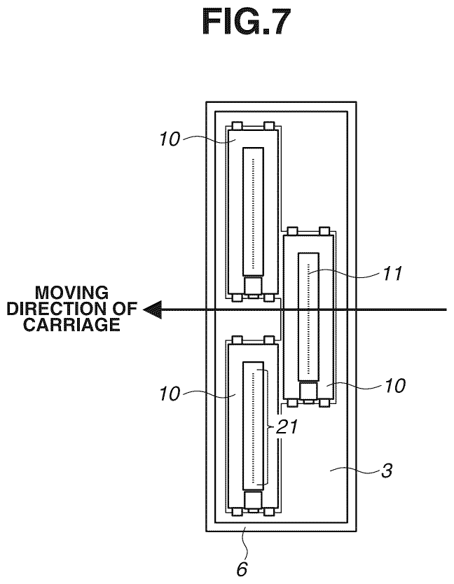

FIG. 7 is a bottom view illustrating the liquid discharge head 100 according to yet another one of the other exemplary embodiments. In FIG. 7, a plurality of the liquid discharge units 10 is juxtaposed in an extending direction of each of the discharge port arrays 21. Further, each of the plurality of liquid discharge units 10 has an overlapping area when viewed from a direction intersecting with each of the discharge port arrays 21. More specifically, the liquid discharge units 10 are arranged in a staggered manner in the direction in which each of the discharge port arrays 21 extends. In the area where the liquid discharge units 10 overlap when viewed from the direction intersecting with the discharge port arrays 21, either of the liquid discharge units 10 may discharge liquid, and both of the liquid discharge units 10 may discharge liquid. As illustrated in FIG. 7, by arranging the liquid discharge units 10 in a staggered manner, it is possible to extend the discharge port arrays 21 to be longer while reducing the width of the liquid discharge head 100 in the direction intersecting with each of the discharge port arrays 21, and thus it is possible to increase the image recording speed.

As described above, by optimizing the direction in which the liquid discharge units 10 are juxtaposed, and the direction in which each of the discharge port arrays 21 extends, it is possible to achieve the liquid discharge head with desired characteristics. Further, since it is possible to juxtapose the number of the liquid discharge units 10, the design freedom degree can be improved.

Appropriate combinations of the configurations according to the exemplary embodiments described above are also applicable.

In summarizing the present disclosure, the present disclosure includes the following configurations.

According to the present disclosure, it is possible to provide a liquid discharge head with its design freedom degree increased.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-048283, filed Mar. 25, 2024, which is hereby incorporated by reference herein in its entirety.

What is claimed is:

1. A liquid discharge head comprising:
a plurality of discharge units each including:
a discharge element substrate configured to discharge liquid;
a pressure adjustment unit configured to reserve the liquid to be discharged from the discharge element substrate, and to adjust a pressure of the liquid; and
a support member configured to fluid-connect the discharge element substrate and the pressure adjustment unit, and to support the discharge element substrate,
wherein the plurality of discharge units is arranged in a juxtaposed manner.

2. The liquid discharge head according to claim 1,
wherein the pressure adjustment unit includes a valve chamber, a pressure control chamber, an opening configured to communicate the valve chamber and the pressure control chamber, and a valve configured to open and close the opening, and
wherein the pressure control chamber is formed of a displaceable flexible member in a part of a surface thereof, and includes a pressing plate displaceable in conjunction with the flexible member, and an urging member configured to urge the pressing plate in a direction in which an inner volume of the pressure control chamber increases, and
wherein the pressure control chamber is configured to open and close the valve in response to a displacement of the pressing plate and the flexible member.

3. The liquid discharge head according to claim 1, further comprising a fixing member configured to integrally fix the plurality of discharge units.

4. The liquid discharge head according to claim 1, further comprising an electric wiring substrate configured to receive power from outside the liquid discharge head,
wherein each of the plurality of discharge units includes an electric connection member configured to electrically connect to the electric wiring substrate, and
wherein power is supplied from the electric wiring substrate to the discharge element substrate of each of the plurality of discharge units via the electric connection member.

5. The liquid discharge head according to claim 4, further comprising a fixing member configured to integrally fix the plurality of discharge units,
wherein the electric wiring substrate is fixed to the fixing member.

6. The liquid discharge head according to claim 1,
wherein the plurality of discharge units is juxtaposed in a first direction,
wherein the discharge element substrate of each of the plurality of discharge units has a discharge port array configured to discharge the liquid, and
wherein the discharge port array of each of the plurality of discharge units extends in a second direction intersecting with the first direction.

7. The liquid discharge head according to claim 6, wherein each of the plurality of discharge units has an overlapping area viewed from the first direction.

8. The liquid discharge head according to claim 1,
wherein the discharge element substrate of each of the plurality of discharge units has a discharge port array configured to discharge the liquid, and
wherein the plurality of discharge units is juxtaposed in a direction in which the discharge port array extends.

9. The liquid discharge head according to claim 1, wherein the pressure adjustment unit includes a circulation pump configured to circulate the liquid in each of the plurality of discharge units.

10. The liquid discharge head according to claim 4,
wherein the pressure adjustment unit includes a circulation pump configured to circulate the liquid in each of the plurality of discharge units, and
wherein power is supplied to the circulation pump from the electric wiring substrate.

11. A liquid discharge apparatus comprising:
a discharge head including a plurality of discharge units arranged in a juxtaposed manner, each of the plurality of discharge units including
a discharge element substrate configured to discharge liquid,
a pressure adjustment unit configured to reserve the liquid to be discharged from the discharge element substrate, and to adjust a pressure of the liquid, and
a support member configured to fluid-connect the discharge element substrate and the pressure adjustment unit, and to support the discharge element substrate; and
a carriage on which the liquid discharge head is mounted, and configured to move relative to a recording medium to which the liquid is discharged from the liquid discharge head,
wherein the carriage moves in a direction in which the plurality of discharge units is arranged in a juxtaposed manner.
